(19) United States
(12) Patent Application Publication
(10) Pub. No.: US 2013/0071604 A1
(43) Pub. Date: Mar. 21, 2013

(54) COMPOSITE PANEL, A COMPOSITE PANEL WITH AN EDGE BAND, AND METHOD OF APPLYING AND MANUFACTURING THE SAME

(71) Applicants: François Lemieux, Drummondville (CA); Thomas Libanet, Drummondville (CA); Sébastien Martel, Grand-Saint-Esprit (CA); Matthieu Boudreault, Drummondville (CA)

(72) Inventors: François Lemieux, Drummondville (CA); Thomas Libanet, Drummondville (CA); Sébastien Martel, Grand-Saint-Esprit (CA); Matthieu Boudreault, Drummondville (CA)

(73) Assignee: ANNEXAIR INC., Drummondville (CA)

(21) Appl. No.: 13/234,845

(22) Filed: Sep. 16, 2011

(51) Int. Cl. B32B 3/02; B32B 37/00; B32B 37/12; B32B 3/26

(52) U.S. Cl. 428/71; 156/182

(57) ABSTRACT

A rigid composite panel 10 for insulating an installation such as a furnace or cooler (HVAC units). The panel 10 has a thermally insulating core 20, at least two laminate assemblies 30 which are bonded to the core 20 thus forming a sandwich, and an edge band 40 adhesively applied to the edges of the sandwich 50 so as to provide a smooth, continuous, and impermeable seal around said edges. There is also claimed a method for manufacturing a rigid composite panel 10 having an edge band 40, each laminate assembly being pretreated by plasma before the edge band 40 is bonded to the panel 10. Each laminate assembly 30 consists of a thin layer of polymer 38, as well as sheets 36 bonded to the surfaces of the layer 38.

### FIELD OF THE INVENTION

The present invention relates to a composite panel. More particularly, the present invention relates to a composite panel and edge band applied to the panel for insulating an installation from its surrounding environment.

### BACKGROUND OF THE INVENTION

Known in the art are composite panels typically consisting of two aluminum or other metal exterior planar surfaces sandwiching a typically polyurethane foam core. These panels are used in air-conditioning and heating system ventilation installations on walls and doors in order to insulate the installation from the outside environment. Specifically, known to the Applicant are the composite panels of the company P3 srl of Italy, which provides examples of such composite panels in their product catalogue. Similarly, edge bands, which contour the edges of a panel, are known for wood panels.

More specifically, known to the Applicant is European patent No. EP 1 626 133 B1 granted to Lambert and made public Aug. 30, 2006. This document relates to a thin thermal insulator having multiple layers. More specifically, Lambert teaches a multilayer insulator having two aluminum sheets on its exterior surfaces and at least three insulating layers which include at least one air-bubble film and at least one plastic foam, preferably polyethylene. According to Lambert, the invention resides in the insulator having at least two supplementary aluminum sheets for placing inside the insulator, and which separate the insulating layers. The insulating layers are welded or glued homogenously along their entire surface. Lambert does not suggest an edge band.

Also known to the Applicant is US patent application publication no. US 2010/0071294 A1 filed by Crunkleton and made public Mar. 25, 2010. Crunkleton teaches a metal composite tile used for decorative purposes which consists of first and second metal sheets sandwiching a non-metal core (a polymer of some kind). A release paper is removably adhered to the first metal sheet for decorative purposes. Crunkleton does not suggest that the tile provides insulation or corrosion-resistant properties.

U.S. Pat. No. 7,799,710 B1 granted Sep. 21, 2010 to Tan teaches a foamed composite armor laminate for providing superior impact and ballistic resistance properties. The armor consists of multiple alternating plies of open or closed cell polymeric foam laminated with interleaved layers of ballistic resistant fabric such as metallic or ceramic sheets, plates or fabrics. Tan does not suggest an edge band, nor does the armor laminate seem to provide any insulating or corrosion-resistant properties.

The Applicant is aware of the case study published in the May, 2011 edition of British Plastics and Rubber entitled “Case study: Plasma activation eliminates masking and safeguards glass fibre composites”. The article discussed using plasma pretreatment to increase the surface energy of a plastic material so as to increase the adhesion of the material to a foam. The plasma activates the surface of metals, plastics, glass or ceramics, thus increasing the adhesive strength of the material when an adhesive is applied thereto.

Other prior art known to the Applicant include U.S. Pat. No. 4,543,295; US patent application publication nos.: 2005/0037188 A1; 2005/0019535 A1; 2004/0018348 A1; as well as foreign publications JP3205162 A and GB 2 398 096 A.

Certain edge bands are also known in the art. A technical product sheet produced by Hexcel Corporation of Stamford, Conn. and entitled “Sandwich Panel Fabrication Technology” discloses on page 8 various types of edge closures including fillers, bonded sections, press-fit components, and tapes. The purported purpose of these edge closures is to seal the sandwich panel so as to prevent moisture ingress. U.S. Pat. No. 7,168,148 B2 granted to Groll on Jan. 30, 2007 teaches a method of manufacturing composite cookware. The cookware comprises a bonded composite sheet consisting of an aluminum layer sandwiched between two layers of stainless steel. An edge of the aluminum layer is then exposed and treated by a micro arc oxidation process to form an aluminum oxide coating on the exposed edge. Other prior art known to the Applicant relating to edge bands include U.S. Pat. Nos.: 6,063,475; 7,846,536 B2; and US patent application publication number 2010/0004399 A1.

Also known to the Applicant are the substantial drawbacks associated with some of the prior art panels and/or edge bands, notably: a) two thin aluminum or metal exterior planar surfaces are not effective at preventing corrosion when the panel is exposed to the outside environment; b) many prior art panels lack the rigidity required for certain applications; c) as illustrated in FIGS. 1 and 2, prior art edge bands, sometimes referred to as “clip” bands, are often installed such that there is gap between the edge band surface and the foam core in which moisture, debris etc. accumulate, thus causing potential fungal growth, reducing the thermal effectiveness of the panel, and creating cleanliness issues; d) prior art panels also produce a thermal bridge between one exterior surface and another, thereby reducing the insulating effectiveness of the panel; etc.

Consequently, there is still presently a need for a rigid composite panel and/or edge band that can provide full thermal insulation, while at the same time providing electrical, fire and water resistivity. Although different panels are already known and satisfy at least one of the above needs, there is still a need for a composite panel and/or edge band which will meet a majority, if not all, of the requirements described above.

### SUMMARY OF THE INVENTION

An object of the present invention is to provide a composite panel and/or edge band that addresses the above-mentioned needs.

According to the present invention, there is provided a rigid composite panel for mounting onto an installation and thermally insulating the installation from a surrounding environment, the panel comprising:
a thermally insulating foam core;
at least two laminate assemblies, each laminate assembly having an inner surface bondable to the foam core thereby forming a sandwich having edges, and an outer surface interacting with the surrounding environment, each laminate assembly providing additional thermal insulation and impact resistance; and
an edge band seamlessly mountable to the edges of the sandwich for preventing fluid and debris from entering the sandwich and contacting the foam core;
   wherein each laminate assembly is treated before the edge band is mounted to the edges of the sandwich so as to increase an overall adhesive strength between the edges of the sandwich and the edge band and so as to allow for a smooth, continuous and impermeable seal around the edges of the sandwich.

According to the present invention, there is provided a method for manufacturing a rigid composite panel having an edge band, the method comprising the steps of:
a) assembling a sandwich having edges, the sandwich consisting of a thermally insulating foam core bonded between at least two laminate assemblies;
b) treating each laminate assembly so as to increase the adhesive properties of the edges of the sandwich; and
c) bonding the edge band to the edges of the sandwich creating a seamless, continuous and impermeable seal around the edges of the sandwich.

Preferably, the present invention permits an installation, such as an industrial cooler or furnace for example, to be properly thermally and electrically insulated from a surrounding environment. In a preferred embodiment, the panel according to the present invention is installed onto a vertical or horizontal planar surface of the installation, such as a wall for example, thus insulating the installation from its surrounding environment.

Preferably also, the rigid composite panel according to the present invention prevents the ingress and accumulation of fluid or debris into the panel due to the seamless edge band which contours the edges of the sandwich.

Preferably also, the panel according to the present invention provides a measure of structural rigidity so as to resist dents, chips, dimples etc. resulting from impacts or scratches, thus better maintaining the insulation properties for which it is advantageous.

### BRIEF DESCRIPTION OF THE DRAWINGS

These and other objects and advantages of the invention will become apparent upon reading the detailed description and upon referring to the drawings in which:

FIGS. 1 and 2 are views of prior art composite panels equipped with an edge or “clip” band.

FIG. 3 is a perspective view of a rigid composite panel according to the present invention.

FIG. 4 is an exploded perspective view of the composite panel shown in FIG. 3.

FIG. 5 is a cut-away view of the composite panel shown in FIG. 3.

FIG. 6 is a perspective view of a laminate assembly, according to a preferred embodiment of the present invention.

FIG. 7 is a partial cut-away view along a line VII-VII of the laminate assembly shown in FIG. 6.

FIG. 8 is a perspective view of a foam core, according to a preferred embodiment of the present invention.

FIG. 9 is a perspective view of an edge band, according to a preferred embodiment of the present invention.

FIG. 10 is a cut-away view of support edge bands for structurally supporting a laminate assembly, according to a preferred embodiment of the present invention.

FIG. 10A is a close-up view a corner of the support edge bands shown in FIG. 10.

FIG. 11 is a cut-away view of a sheet or laminate assembly dividing a foam core, according to a preferred embodiment of the present invention.

FIG. 12 is a cut-away view of a two-step composite panel, according to a preferred embodiment of the present invention.

### DETAILED DESCRIPTION OF PREFERRED EMBODIMENTS OF THE INVENTION

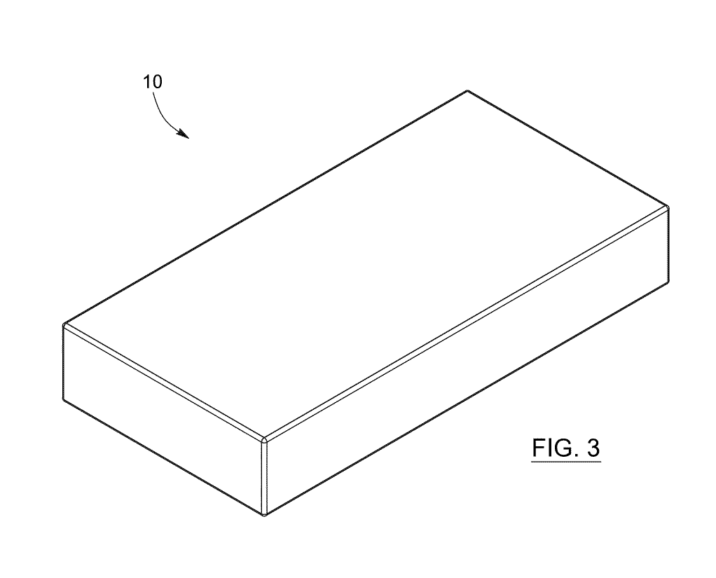

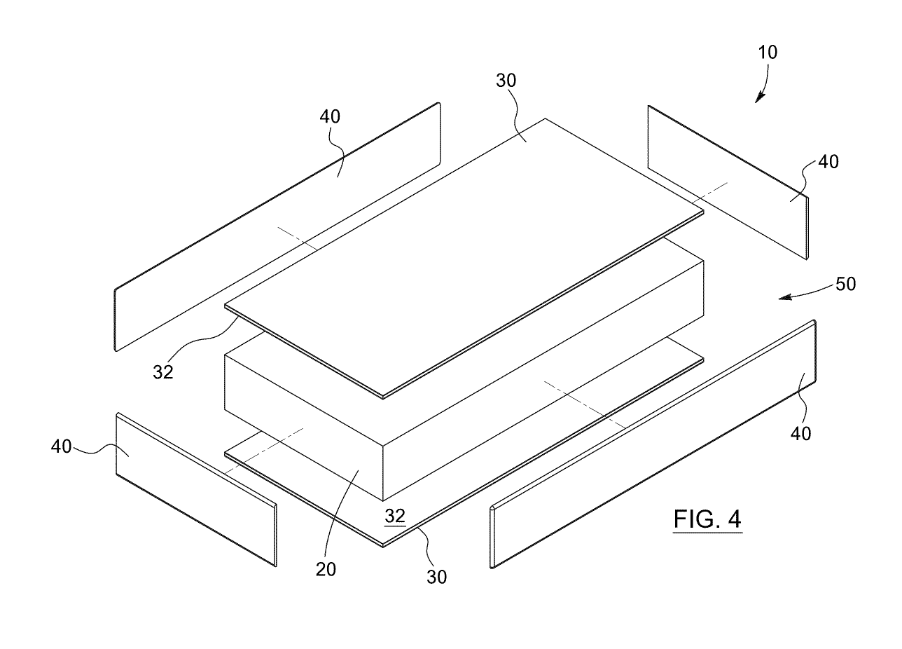

According to the present invention, and as shown in FIGS. 3 to 4, the rigid composite panel 10 is composed of a thermally insulating foam core 20, at least two laminate assemblies 30, and an edge band 40.

Referring to FIG. 4, the laminate assemblies 30 are bonded, preferably by an adhesive, to the foam core 20. The inner surfaces 32 of the laminate assemblies 30 receive an adhesive which allows them to be bonded or attached to the horizontal surfaces (in the sense shown in FIG. 4) of the foam core 20. The bonding of the laminate assemblies 30 to the foam core 20 creates a sandwich 50 with edges. The edge band 40 (shown in an exploded configuration) is then bonded to these edges, preferably by using an adhesive.

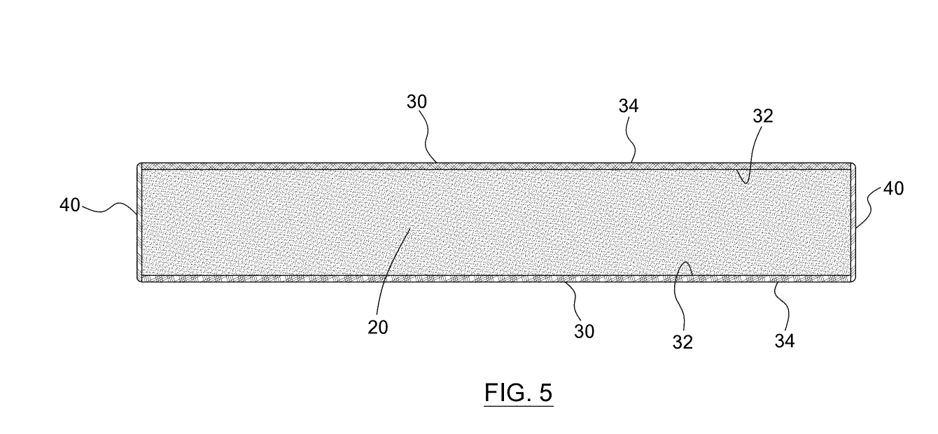

FIG. 5 provides a cross-sectional view of the panel 10 when fully assembled and shows the relationship between the foam core 20, the laminate assemblies 30 and the edge band 40. Thus, the rigid composite panel 10 of the present invention is formed and ready to be used for insulating purposes.

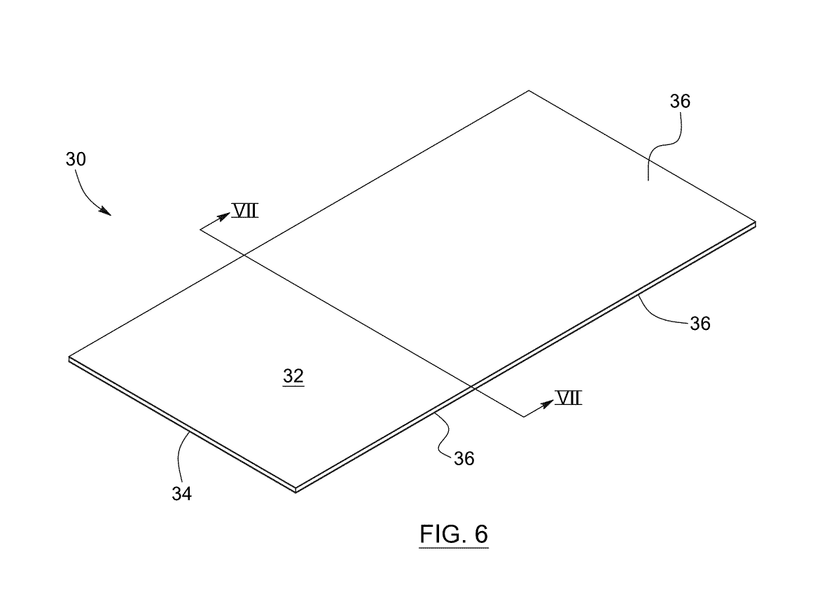

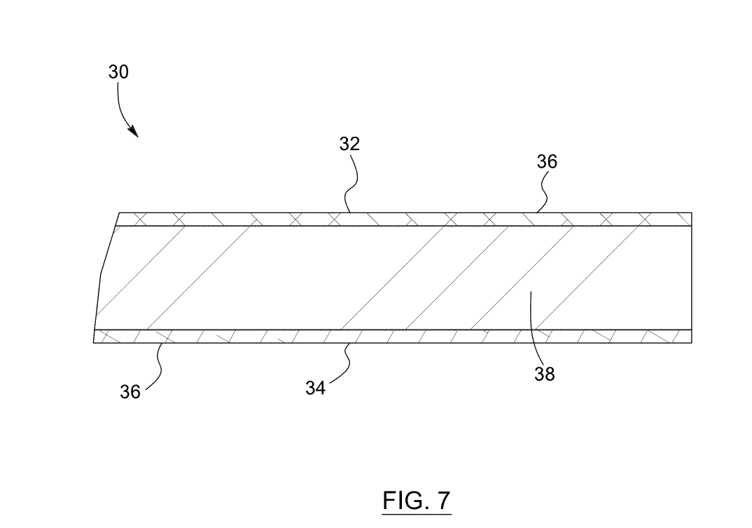

Turning now to the components and features of the panel 10, particularly the laminate assemblies 30, FIGS. 6 and 7 illustrate a preferred embodiment of the laminate assemblies 30. Each laminate assembly 30 has an inner and outer surfaces 32,34. The inner surface 32 is bonded to the foam core 20, again preferably by adhesive, although other techniques such as mechanical fasteners, for example, can be used. The outer surface 34 is exposed to the surrounding environment of the composite panel 10. The inner and outer surfaces 32, 34 are also preferably coated so as to provide insulation, fire retardation, electrical resistance, corrosion resistance etc. properties to the laminate assembly 30. These coatings can be PVDF or PE.

Each laminate assembly 30 preferably also has at least two laminated sheets 36 which are each preferably made of plastic, aluminum, stainless steel, PVC, ABS, or other similar materials known in the art. The material of the sheets 36 allows them to resist indentations, nicks, scratches, or bumps, thus preserving the properties of the laminate assembly 30, as explained in more detail below. The sheets preferably have a thickness of about 0.0118 inches, but this thickness can vary depending on the material used for their fabrication and the requirements of the installation, as apparent to a person skilled in the art. The laminate assembly 30 also preferably comprises a polymeric layer 38, which is inserted between the two sheets 36 and bonded thereto, preferably by an adhesive. The layer 38 is preferably made of any insulating polymer, such as low-density polyethylene (LDPE), fire-retardant mineral, and any other such insulating materials known in the art.

Turning now to FIG. 8, the foam core 20 is the principal thermal insulator of the composite panel 10. The length and width of the core 20 can be varied so as to match the dimensions of the laminate assemblies 30. The foam core 20 is preferably rigid foam so as to reinforce the structural rigidity to the panel 10. Preferably, the thickness of the core 20 is about 1.75 inches, but this thickness can vary depending on the material used for the core 20 and the installation requirements, as apparent to a person skilled in the art. The core 20 is preferably bonded to the inner surfaces 32 of the laminate assemblies 30 by any suitable adhesive known in the art. Preferably, the core 20 is made from an insulating polymer such as EPS (STD, NEOPOR), polyisocyanurate, etc. known in the art.

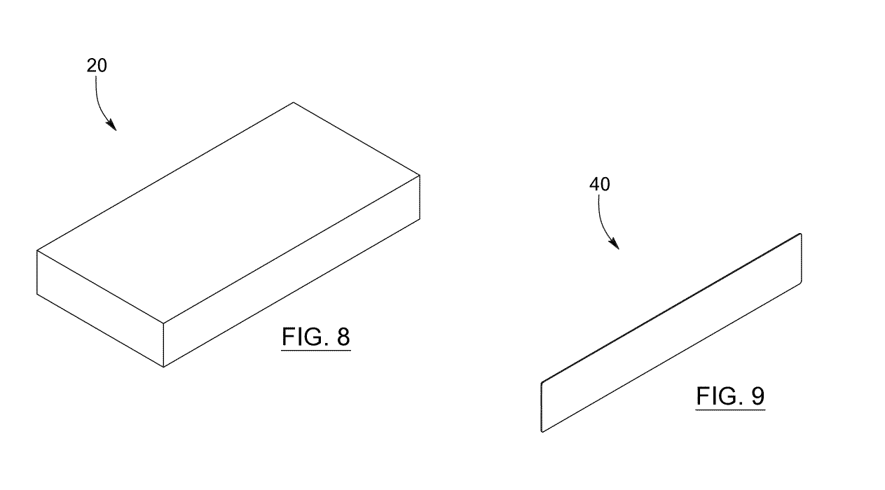

FIG. 9 illustrates the edge band 40 according to a preferred embodiment of the present invention. The edge band 40 provides a seamless, smooth, and continuous seal between the edges of the sandwich 50 formed by the laminate assemblies 30 and the foam core 20, thereby preventing the ingress and/or accumulation of moisture and/or debris. The edge band 40 is bonded to the edges of the sandwich 50 by any suitable adhesive known in the art. The edge band 40 can be one continuous piece, such as a tape, which is bonded by rolling out the tape and applying it to the edges of the sandwich 50. In another preferred embodiment, the edge band 40 can be discrete pieces or strips, as illustrated in FIG. 4, which are each bonded separately to a an edge of the sandwich 50. It should be noted that even if the edge band 40 consists of discrete strips, the strips would be bonded to the sandwich and to each other so as to provide a seamless, smooth and continuous seal. Preferably, the edge band 40 is made from rigid or flexible PVC, ABS, TPE, polyethylene and/or any other suitable material known in the art. The edge band 40 is able to be bonded seamlessly because the band 40 is tangentially assembled with adhesive to the exterior surfaces of the laminate assemblies 30 and foam core 20 (i.e. the edges of the sandwich 50).

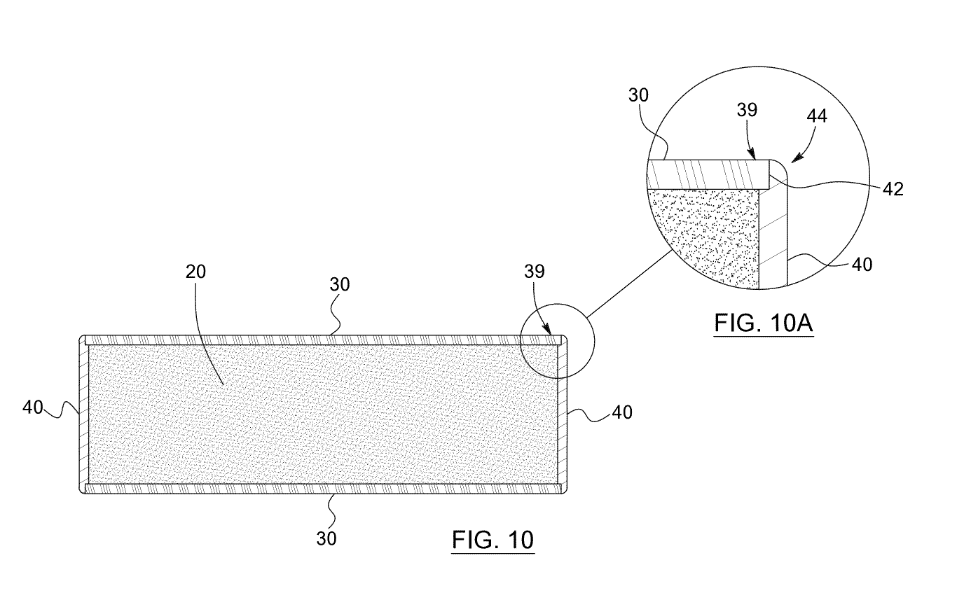

In a preferred embodiment illustrated in FIG. 10, the edge band 40 provides structural support and reinforcement to the panel 10, as explained hereinbelow. In this embodiment, the edge band 40 has notches 42 at each end 44 of the edge band 40. The notches 42 are designed, configured and manufactured to receive a corresponding end 39 of the laminate assembly 30. When the end 39 is adhesively received in the notch 42, the laminate assembly 30 is constrained in its motion relative to the edge band 40, as illustrated in FIG. 10.

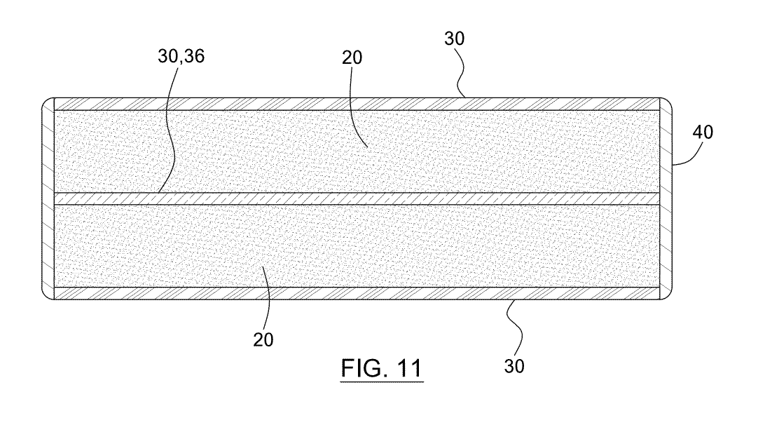

Preferably, and as illustrated in FIG. 11, the panel 10 can include an additional laminate assembly 30 and/or sheet 36 which is inserted into the panel 10 so as to divide its thickness (and the foam core 20) by a certain amount, i.e. in half for example. In another preferential embodiment, the panel 10 can be a “double” panel 10, meaning that an additional foam core 20 can be bonded to either one of the outer surfaces 34 of the laminate assemblies 30. Once so bonded, an additional laminate assembly 30 can be bonded to the non-bonded surface of the additional foam core 20, thus forming a double-layered panel. Of course, numerous variants on this design are possible, as apparent to a person skilled in the art. For example, the panel 10 can be made “triple”, “quadruple”, or any multiple according to this preferred embodiment depending on the insulation requirements and the installation size constraints. The panel 10 can also comprise alternating layers of foam core 20, laminate assemblies 30, or can be “stacked” meaning that the panels 10 are stacked together. In another preferred embodiment, the panel 10 can have a non-quadrilateral profile such as, but not limited to, a triangle, a circle, an ellipse, and any other shape or size that would be suitable for a given installation.

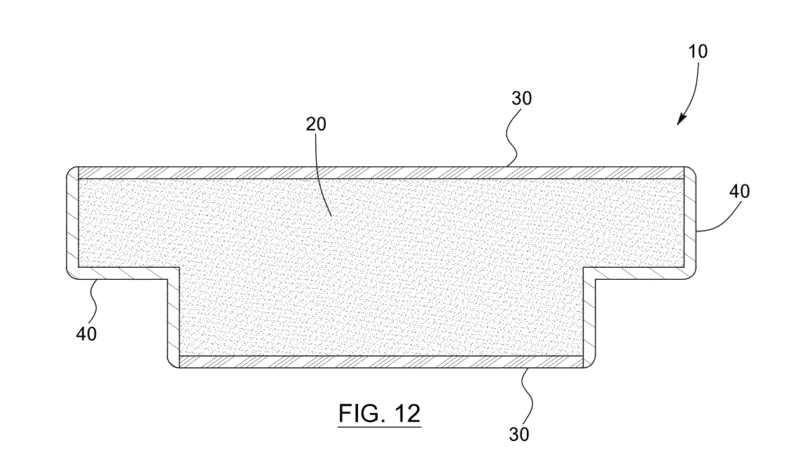

The panel 10 according to the present invention can be any three-dimensional shape and is not limited to parallelepipeds. For example, and as illustrated in FIG. 12, the panel 10 can have a “step” configuration wherein both laminate assemblies 30 are not of equal dimension. Similarly, the edge bands 40 can have a “z” or “s” configuration so as to match the dimensions of the laminate assemblies 30, and depending on the installation's requirements, as apparent to a person skilled in the art. Of course, numerous other shapes, configurations and/or geometries are possible.

There is also provided a method for manufacturing a rigid composite panel 10 having an edge band 40. The method has the steps of assembling the sandwich 50 with edges, as described in more detail above. Then, each laminate assembly 30 is treated so as to increase its adhesive properties, and the edge band 40 is finally bonded to the edges of the sandwich 50 so as to create the seamless, continuous and impermeable seal which is described above. When treating each laminate assembly 30, the polymeric layer 38 is preferably treated along its exposed edges. It is understood that each laminate assembly 30 can be treated before or after the assembly of the sandwich 50. In fact, each laminate assembly 30 can be treated at any time before the edge band 40 is bonded to the edges of the sandwich 50.

The above-mentioned treatment in the context of the invention is preferably plasma treatment, but can also be corona treatment. It is understood in the art that plasma treatment has the effect of activating the surface of numerous types of materials such as plastics, metals and glass. By activating the surface of these materials, the surface energy of a surface which is to be bonded is increased. The higher the surface energy, the better the subsequent adhesion the surface will have to another material, such as a plastic. Thus, a stronger adhesive bond between the edges of the polymeric layer 38 and the edge band 40, as well as between the edges of the sandwich 50 and the edge band 40, is obtained by increasing the surface energy of the polymeric layer 38 via plasma treatment prior to the edge band 40 being adhesively bonded to the edges.

Furthermore, the present invention is a substantial improvement over the prior art in that, by virtue of its design and components, the rigid composite panel 10 with an edge band 40 is seamless, has a higher surface energy, is lightweight, easy to install, and offers unique thermal insulating properties when compared to the panels known in the art. Hence, it may now be appreciated that the present invention represents important unforeseeable advantages over other panels known in the prior art, in that the panel 10 according to the present invention prevents the ingress and/or accumulation of fluids and/or debris because of the continuous seal of the sandwich 50 provided by the edge band 40. Thus, the insulation properties are better preserved and enhanced because no foreign matter that may negatively affect the insulating qualities of the panel 10 is introduced into the panel 10. The seamless seal also provides a further unexpected advantage in that the growth of mildew and/or mold is greatly prohibited and even eliminated for most installations.

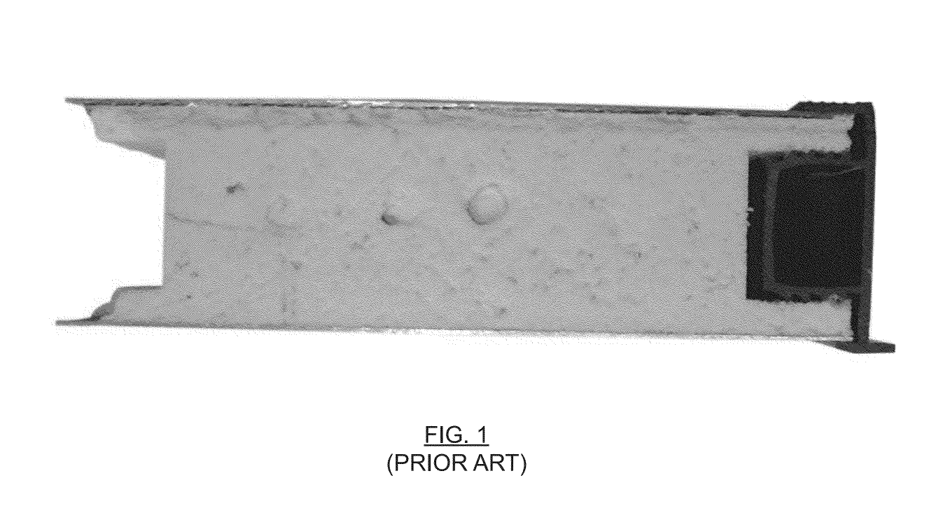

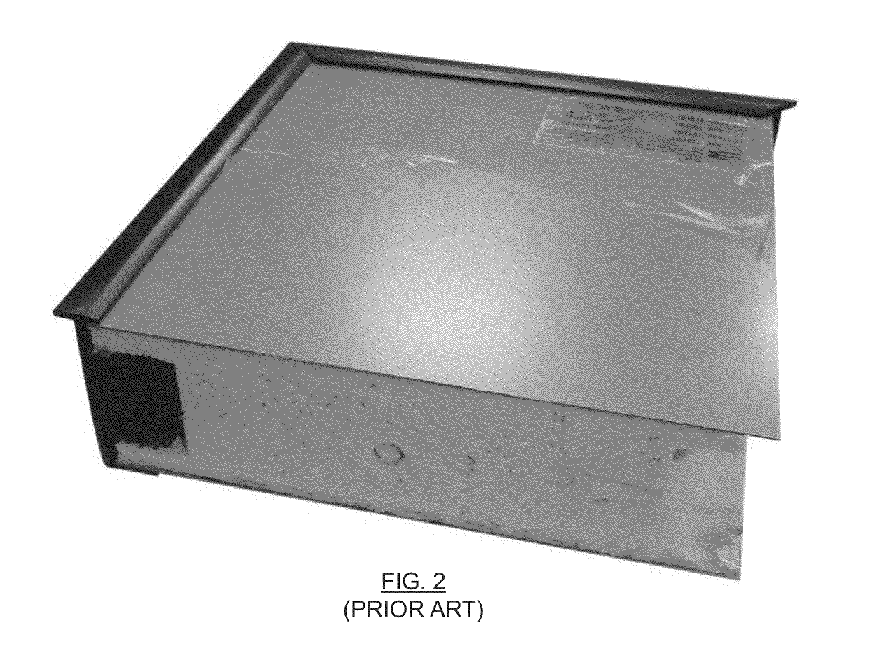

Indeed, contrary to panel shown in FIGS. 1 and 2, the edge band 40 according to the present invention forms a seamless seal with the sandwich 50 of the panel 10, and this, without the use of mechanical fasteners in a preferred embodiment, which advantageously reduces manufacturing costs and manufacturing times. More specifically, the seamless edge band 40 leaves no gap between the band 40 and the foam core 20 into which moisture and/or debris may ingress and/or accumulate. In a preferred embodiment, the edge band 40 beneficially provides structural support to the panel 10 by employing notches 42, which support and retain the ends 39 of the laminate assemblies 30.

Yet another advantage of the panel 10 according to the present invention is that the coating on the inner and outer surfaces 32,34 of the laminate assemblies 30 further enhances the desired properties of the panel 10 such as high thermal insulation efficiency, resistance to corrosion, and fire retardation and/or resistance.

The panel 10 according to the present invention is also more rigid than panels known in the art. This rigidity and resistance to impact forces is derived from the material of the sheets 36, the structure of the foam core 20, and also from the reinforcement that results from having multiple layers of laminate assembly 30 and foam core 20. Further rigidity is achieved by adhesively sealing all the components of the panel 10. This rigidity and resistance to impacts and indentations is important because, as it is well understood in the art, when composite panels have indentations or scratches, the panels are less effective because the scratches can remove beneficial coatings on the outer surfaces of the panels, and the indentations can create a thermal bridge between the two sheets of the panel, thus allowing energy to bypass the insulating foam core and reducing the insulation efficiency of the panel.

Of course, the scope of the claims should not be limited by the preferred embodiments set forth in the examples, but should be given the broadest interpretation consistent with the description as a whole. Numerous modifications could be made to the above-described embodiments without departing from the scope of the claims, as apparent to a person skilled in the art. Furthermore, it is apparent that this invention can apply to many other uses.

1. A rigid composite panel for mounting onto an installation and thermally insulating the installation from a surrounding environment, the panel comprising:
a thermally insulating foam core;
at least two laminate assemblies, each laminate assembly having an inner surface bondable to the foam core thereby forming a sandwich having edges, and an outer surface interacting with the surrounding environment, each laminate assembly providing additional thermal insulation and impact resistance; and
an edge band seamlessly mountable to the edges of the sandwich for preventing fluid and debris from entering the sandwich and contacting the foam core;
wherein each laminate assembly is treated before the edge band is mounted to the edges of the sandwich so as to increase an overall adhesive strength between the edges of the sandwich and the edge band and so as to allow for a smooth, continuous and impermeable seal around the edges of the sandwich.

2. The panel according to claim 1, wherein each laminate assembly comprises a polymeric layer inserted between, and bonded to, two laminated sheets.

3. The panel according to claim 2, wherein the polymeric layer is made from a material selected from the group consisting of low-density polyethylene (LDPE), fire-retardant mineral, polypropylene, and polyethylene terephthalate (PET).

4. The panel according to claim 2, wherein the polymeric layer is bonded to two laminated sheets by an adhesive.

5. The panel according to claim 1 further comprising an additional foam core bonded to an outer surface of either one of the at least two laminate assemblies, and an additional laminate assembly bonded to the additional foam core, thereby creating a composite panel having at least two levels.

6. The panel according to claim 1, wherein an additional laminate assembly or sheet is inserted into the sandwich thereby dividing the foam core.

7. The panel according to claim 1, wherein the foam core is made from a insulating polymer selected from the group consisting of EPS (STD, NEOPOR), polyisocyanurate, and extruded polystyrene (XPS).

8. The panel according to claim 2, wherein each sheet is made from a material selected from a group consisting of aluminum, stainless steel, plastic, PVC, ABS and fiber glass.

9. The panel according to claim 1, wherein the foam core is bonded to the inner surface of each laminate assembly by an adhesive such as liquid polyurethane (PUR) glue.

10. The panel according to claim 1, wherein the edge band is mounted to the edges of the sandwich by an adhesive such as PUR Hot melt glue.

11. The panel according to claim 1, wherein the inner and outer surfaces of each laminate assembly are coated so as to provide insulation, corrosion resistance and fire-retardant properties to the inner and outer surfaces.

12. The panel according to claim 11, wherein the inner and outer surfaces are coated with a coating selected from the group consisting of PVDF and PE.

13. The panel according to claim 1, wherein the edge band is a tape made from a material selected from the group consisting of rigid or flexible PVC, ABS, TPE, polyethylene, polypropylene, and polyethylene terephthalate (PET).

14. The panel according to claim 1, wherein the foam core has a thickness of about 0.625-4 inches.

15. The panel according to claim 2, wherein the each sheet of each laminate assembly has a thickness of about 0.1-0.6 mm.

16. The panel according to claim 2, wherein the polymeric layer of each laminate assembly has a thickness of about 1-6 mm.

17. The panel according to claim 1, wherein said panel is installed on a planar surface of the installation.

18. The panel according to claim 1, wherein the edge band has a notch at each end of the edge band for adhesively receiving a corresponding end of the laminate assembly, thus providing structural support and reinforcement to the laminate assembly.

19. The panel according to claim 2, wherein the treatment of each laminate assembly is performed on the polymeric layer.

20. The panel according to claim 1, wherein the treatment is plasma treatment.

21. A method for manufacturing a rigid composite panel having an edge band, the method comprising the steps of:
a) assembling a sandwich having edges, the sandwich consisting of a thermally insulating foam core bonded between at least two laminate assemblies;
b) treating each laminate assembly so as to increase the adhesive properties of the edges of the sandwich; and
c) bonding the edge band to the edges of the sandwich creating a seamless, continuous and impermeable seal around the edges of the sandwich.

22. The method according to claim 21, wherein the assembly of the sandwich in step a) is done by an adhesive.

23. The method according to claim 21, wherein the treatment of step b) is a plasma treatment.

24. The method according to claim 21, wherein the edge band is bonded to the edges of the sandwich in step c) by an adhesive.
